(19) United States
(12) Patent Application Publication
(10) Pub. No.: US 2007/0226782 A1
(43) Pub. Date: Sep. 27, 2007

(54) System for updating software in a terminal when access of the terminal is authenticated

(75) Inventors: Izuru Sato, Kawasaki (JP); Takeshi Ohnishi, Fukuoka (JP); Hiroyuki Taniguchi, Kawasaki (JP); Takao Ogura, Kawasaki (JP); Kouhei Iseda, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/508,645

(22) Filed: Aug. 23, 2006

(30) Foreign Application Priority Data
Mar. 24, 2006 (JP) 2006-83540

(51) Int. Cl. H04L 9/32; G06K 9/00; G06F 17/30; G06F 15/16; G06F 7/04; G06F 7/58; G06K 19/00; G06F 12/14; G06F 11/30

(52) U.S. Cl. 726/4; 713/191

(57) ABSTRACT

A network system is disclosed that comprises an access point that relays communication between a client and a LAN; and an authenticating server that authenticate an access of the client through the access point, wherein the authenticating server comprises a judging unit that judges the application state of a security program in the client that tries to connect with the LAN through the access point and notifies the client of the result of the judgment; and a data providing unit that provides data necessary for updating the application state to the client according to the result of the judgment and in response to a request of the client.

### CROSS-REFERENCE TO RELATED APPLICATIONS

This application is based upon and claims the benefit of priority from the prior Japanese Patent Application No. 2006-83540, filed on Mar. 24, 2006, the entire contents of which are incorporated herein by reference.

### BACKGROUND OF THE INVENTION

1. Field of the Invention

The present invention relates to network access authentication of a client PC and update of software in the client PC, and more specifically to improvement of the efficiency of processing by coupling the authentication with the update of the software.

2. Description of the Related Art

In recent years, damage caused by malicious programs such as computer viruses (hereinafter, “viruses”) worms, etc., that infect computers (hereinafter, “PC”) has been spreading.

Operations that are not intended by a user of the PC, crash, etc., may occur when a PC is infected with a virus, worm, etc. A state where a password, etc., that have been inputted by the user are leaked may occur when a PC is infected with spy-ware. In addition, a PC may become a zombie PC that transmits spam when infected.

When a PC is infected with a virus, etc., the user thereof suffers damage such as loss of data, delay of work, etc. When a PC is infected with spy-ware, passwords used for systems such as online-banking, etc., may be stolen and the user of the PC may suffer financial damage. When a PC is infected with spy-ware that has appeared recently and aims at stealing trade secrets, risk may arise that the trade secrets of a company that uses the PC are known to competitor companies and the competitiveness of the company is lost.

To suppress the risk, a PC connected with a network always must have taken measures against attacks of viruses, etc. To take measures against viruses, etc., the user must download and install a virus definition file of anti-virus software, etc., applying patches provided by the OS vender.

However, in a company that uses many PCs connected with a network, it is difficult to keep software of all the PCs updated. Software may not be updated for various reasons such as the cases where a PC is not booted up and software thereof is not updated for a certain time period for the user's reason, and where a PC is not present in place when a network administrator urges to update because the target PC is a mobile PC.

A technique can be listed that connects a PC with a network that is dedicated to anti-virus measures to prevent a PC connected with a network from infecting with viruses. Various schemes that realize this technique is referred to generally as “quarantine technique”.

The quarantine technique can be classified into four schemes. The four schemes are, a scheme employing DHCP (Dynamic Host Configuration Protocol), a scheme employing an authenticating switch, a scheme employing a client firewall, and a scheme employing a gateway (see, for example, “Why Are Quarantine Networks Not Prevailing?”, Nariaki Suzuki, http://www.atmarkit.co.jp/fsecurity/special/69quantine/quarantine01.html).

According to the first quarantine scheme employing DHCP, a PC is supplied with an IP address for quarantine from a DHCP server. After the PC has completed updating of software in a quarantine environment and has notified the server that administers the quarantine, when the PC obtains an address again based on DHCP, the PC is supplied with an address with which the PC can access the usual in-company LAN.

In this scheme, when the PC uses a static IP address but a DHCP address, it is necessary to interfere the use of network by a PC using ARP (Address Resolution Protocol). To achieve this, an apparatus that detects a PC using a static IP address for each sub-net and interferes communication of the PC using ARP is necessary.

According to the second quarantine scheme employing a LAN switch that has a quarantine function, whether or not a PC that tries to connect with the LAN switch satisfies security at a level required by a network is checked and, when updating is necessary, the PC is isolated from other PCs in the switch and is put in a state where only updating is possible. In this scheme, introduction of a wireless LAN switch supporting the quarantine or a (wired) LAN switch is necessary.

According to the third quarantine scheme employing a client firewall, software on a PC sets firewall software of the PC and, when the PC has completed updating, the software changes the settings such that the PC can access an in-company LAN. In this scheme, the firewall software needs to have been installed in the PC and, therefore, introduction of a function that blocks accesses from PCs that are not installed with firewalls is necessary.

According to the fourth quarantine scheme employing a gateway, the gateway is placed on a path from PCs to an in-company server and, when a PC that needs updating accesses the gateway, the gateway blocks accesses to the server and let the PC execute only updating. In this scheme, the PC is not prevented from accessing other PCs, etc., in the same sub-net as that of the PC.

Conventionally, introduction of non-standard apparatuses is necessary to make accesses from a PC to other PCs impossible and, in addition, authentication is executed twice to a PC that needs quarantining. That is, the authentication is executed when an authenticating server has judged that a PC that takes unsatisfactory measures against viruses, etc., needs quarantine, and when updating of the PC has completed and the PC boots accessing to an in-company LAN.

Though various schemes can be listed as authentication schemes, a common scheme for a commercially available LAN switch having an access controlling function is an authentication scheme according to 802.1X that uses EAP (Extensible Authentication Protocol).

According to authentication employing EAP, an authentication server transmits/receives EAP packets to/from a PC and, after confirming that the PC has authority to connect with a network, transmits an EAP Success message. Having received this message, the PC learns that a network access has been permitted and, using an IP address obtained based on DHCP, etc., or using an IP address set in advance in the PC, starts accessing to resources on the network such as a Web server, etc.

In authentication schemes based on EAP, a protocol that is excellent in terms of security strength is EAP-TLS. According to this protocol, authentication is executed by encapsulating TLS (Transport Layer Security) packets by EAP packets. The TLS protocol is a protocol that realizes encrypted communication and is a protocol almost same as SSL (Secure Socket Layer).

According to TLS protocol, encrypted communication is realized by executing mutual authentication and exchanging keys between a server and a client. According to EAP-TLS, only the portion of the mutual authentication of TLS is utilized. An authenticating server transmits an EAP Success message when the mutual authentication based on TLS has been completed, and admits connection of a PC with a network.

As a conventional technique, a system is disclosed that, in the case where a PC accesses a first network after being authenticated by a server, when the PC has not been permitted to, causes the PC to receive permission to access a second network for files necessary to access the first network (Japanese Patent Application Laid-Open Publication No. 2004-213632). In this manner, an invention described in the above '3632 publication is a method of improving the level of automation in preparing for a PC to access a network.

As described above, in conventional methods, when a PC is quarantined, authentication is executed twice totaling that executed when quarantine is started and that executed when the PC is connected with an ordinary network.

### SUMMARY OF THE INVENTION

Therefore, the object of the present invention is to provide a network system that always completes authentication by executing the authentication once and can start an HTTP (Hypertext Transfer Protocol) access quicker than conventional systems.

In order to achieve the above object, according to a first aspect of the present invention there is provided a network system comprising an access point that relays communication between a client and a LAN; and an authenticating server that authenticate an access of the client through the access point, wherein the authenticating server comprises a judging unit that judges the application state of a security program in the client that tries to connect with the LAN through the access point and notifies the client of the result of the judgment; and a data providing unit that provides data necessary for updating the application state to the client according to the result of the judgment and in response to a request of the client.

Authentication of an access of the client based on EAP (Extensible Authentication Protocol)-TLS (Transport Layer Security) may be executed prior to the judgment of the application state. The authenticating server may compare the state of a patch of the security program received from the client with the latest patch list and notify the client of the location of updating data necessary for the updating using TLS encryption. The authenticating server may transmit a packet that indicates permission of a network access to the client when the authenticating server has received a message notice that indicates completion from the client.

In order to achieve the above object, according to a second aspect of the present invention there is provided an authenticating server disposed in a wire LAN or in a wireless LAN and executes authentication when a client is connected with a network, wherein the authenticating server judges the application state of a patch of a security program of a client that has a LAN function and that is connected with the LAN through a LAN access point, and, as a proxy server, downloads data necessary for updating from an update site and executes updating of the security program of the client.

By applying the present invention, updating of software on the PC can be executed during the procedure of access authentication. A dedicated IP sub-network necessary for conventional quarantine is not necessary. An advantage that the PC can be connected with the LAN by authenticating once can be obtained.

More specifically, the authenticating server can judge whether or not the updating of the PC is necessary based on the transmitted (POST) data. Because the authenticating server judges whether or not the quarantine of the PC is necessary and transmits a list of items to be updated to the PC, the network administrator can adjust dynamically the criteria of requesting the updating of the PC.

When the updating has turned out unnecessary, thereby, authentication is completed and the network can be used as usual.

At the same time when an HTTP access by the PC that has not been set with an IP address is made possible, sites that can be accessed using the proxy server are restricted. Thereby, risk that a Web site on the Internet or an intra-network is accessed by a PC that has not been updated is eliminated.

The present invention has an advantage that, because the PC is updated before obtaining an IP address and accessing a network, even when a port for TCP or UDP has vulnerability, attacks to the vulnerability can be avoided, etc.

### BRIEF DESCRIPTION OF THE DRAWINGS

FIG. 1 shows an exemplary embodiment of the present invention and an assumes an in-company LAN 100;

FIG. 2A shows an operation sequence in an example of application of the present invention to the system of FIG. 1;

FIG. 2B shows a detailed flow of an authentication process of EAP-TLS in the operation sequence of FIG. 2A;

FIG. 3 shows an operation flow of a PC corresponding to FIGS. 2A and 2B;

FIG. 4 shows an operation flow of a authenticating server corresponding to FIGS. 2A and 2B;

FIG. 5A shows an example of an HTTP POST (transmission) message; and

FIG. 5B shows an example of a response to the HTTP POST (transmission).

### DETAILED DESCRIPTION OF THE PREFERRED EMBODIMENTS

An exemplary embodiment of the present invention will be described below referring to the drawings. The exemplary embodiment is only for understanding of the present invention and the technical scope of the present invention is not limited to the embodiment.

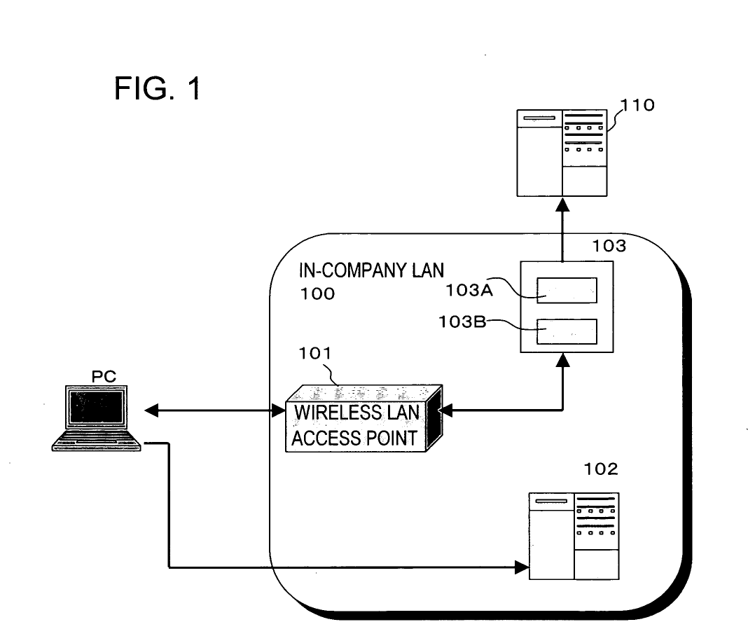

FIG. 1 shows the exemplary embodiment of the present invention and an in-company LAN 100 is assumed as the LAN (Local Area Network).

The in-company LAN 100 has a 802.1X function and includes a wireless LAN access point 101 having a RADIUS (Remote Authentication Dual-In-User Service) client function in the company, and an RADIUS authenticating server 103. Though a case for a wireless LAN will be described as the exemplary embodiment, the present invention is not limited to the wireless LAN and can be applied to a wired LAN and, in such a case, wired access points but wireless access points are used.

This in-company LAN 100 is connected with a Web site 110 for updating, another Web site 102, and a client (a PC: Personal Computer) having a wireless LAN function.

The wireless LAN access point 101 is connected with the in-company LAN 100. The PC is connected with the wireless LAN access point 101 and is a client that uses the Web site 102, etc.

The wireless LAN access point 101 has a 802.1X function and, after confirming that a PC that tries to connect is an authorized user, permits the connection.

At this time, the wireless LAN access point 101 encapsulates a packet to be authenticated into a RADIUS packet and requests the RADIUS authenticating server 103 to substitute authentication. The Web site 110 for updating provides a security patch (corrective difference) of the PC. Another Web site 102 is a site to be used for business operation, etc., and provides services to a PC connected with the wireless LAN.

To implement the present invention, as to the wireless LAN access point 101 having a 802.1x function, the Web server 102, 110, etc., existing ones can be used as they are. Those that need changes are the PC and the RADIUS authenticating server 103.

The PC has a function that collects states such as the state of patch application, version of virus definition files, etc. The PC has a function that transmits an HTTP request using a TLS session created in EAP-TLS authentication.

The RADIUS authenticating server 103 has a judging unit 103a and a data providing unit 103b as a function unit that realizes a processing function described later, and has a function of an HTTP proxy server that relays an HTTP request transmitted from the PC using a TLS session. When the server 103 is used as an HTTP proxy server, it is improper to use the server 103 for the purpose other than updating of the PC (downloading of a patch file, etc.). Therefore, the HTTP proxy server concurrently has an access controlling function that applies a filter depending on an access destination of HTTP.

The above judging unit 103a has a function that compares the patch application state of the PC transmitted from the PC with the latest patch list.

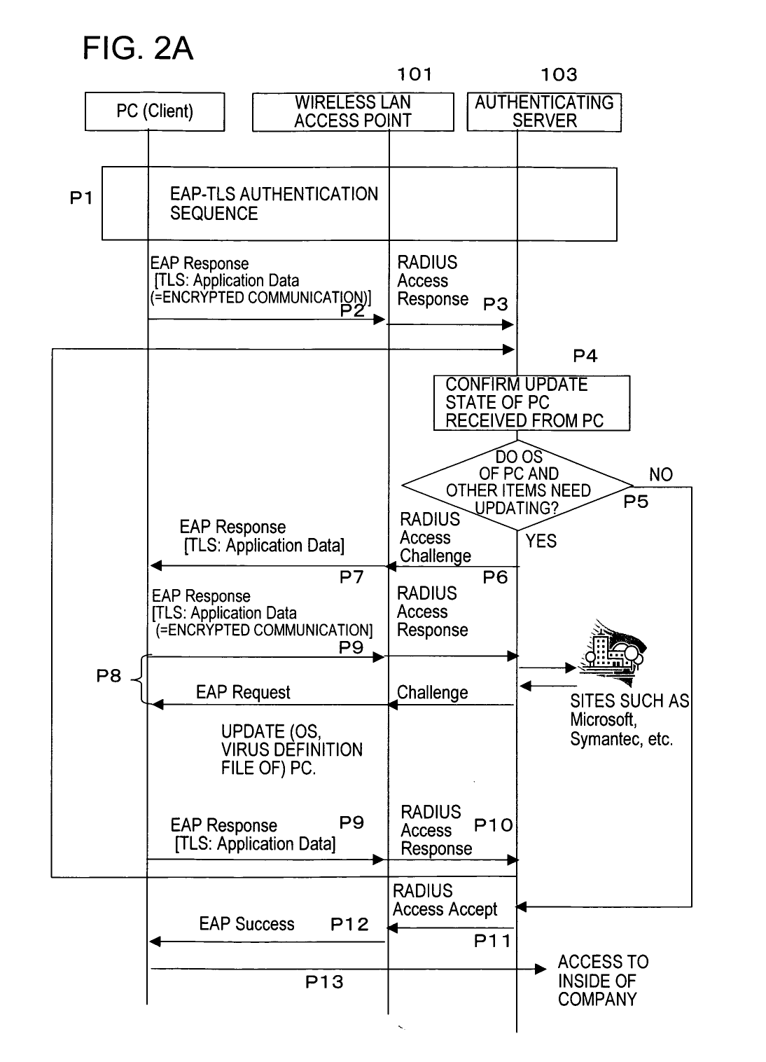

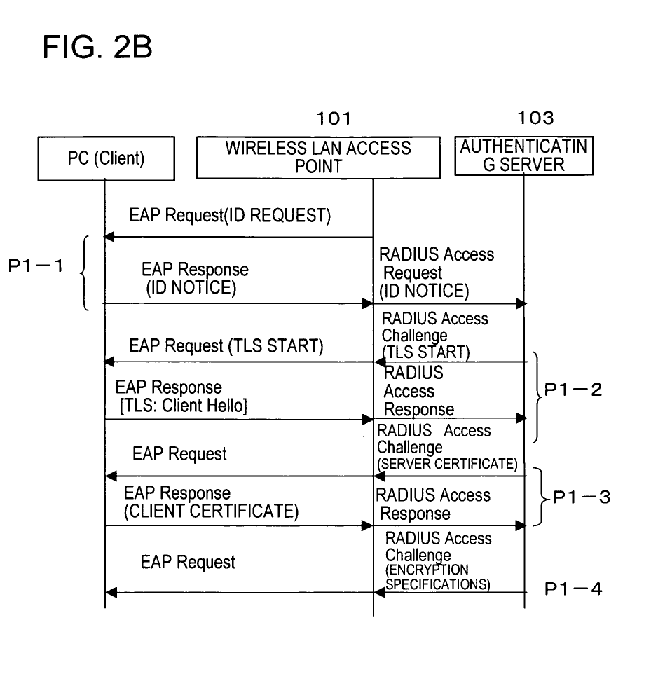

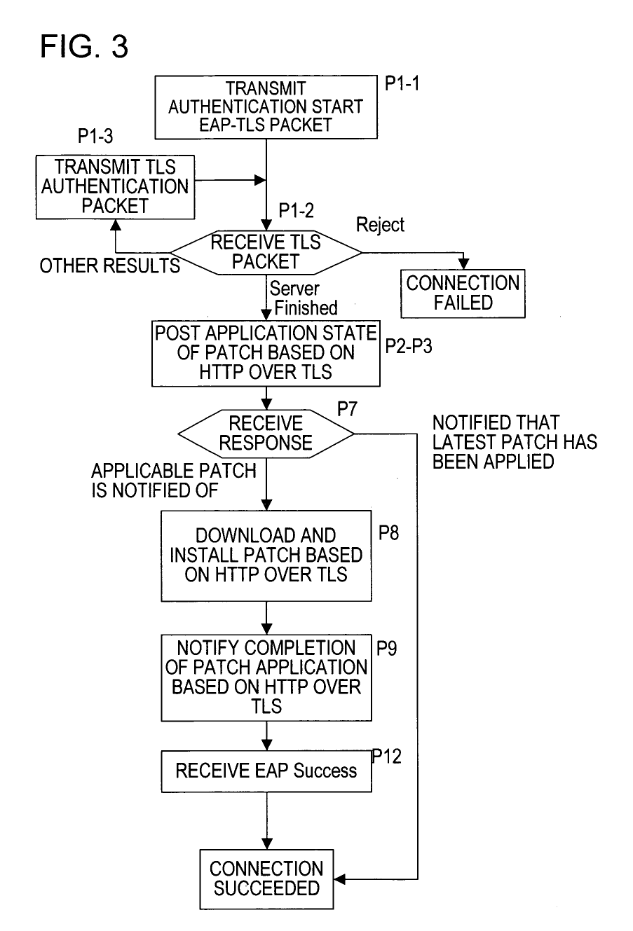

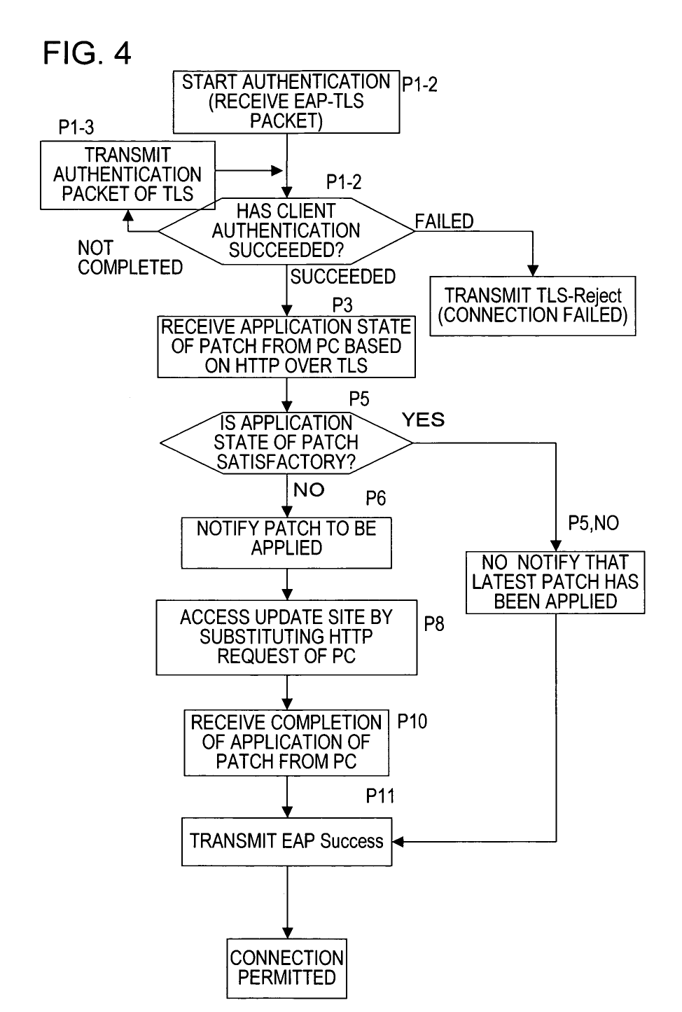

FIGS. 2A and 2B show an operation sequence in an example of applying the present invention to the system of FIG. 1. FIGS. 3 and 4 are operation flows respectively of the PC and the authenticating server 103. In FIGS. 3 and 4, same step reference numerals are given to process steps that correspond to those in FIGS. 2A and 2B.

Referring to these figures, an authentication operation of the present invention will be described.

In FIG. 2A, first, access authentication using EAP (Extensible Authentication Protocol)-TLS (Transport Layer Security) is executed (process step P1).

The authentication process of EAP-TLS is a known authentication sequence (see http://www.soi.wide.ad.jp/class/20030038/slides/44/index_{—}35.html accessed March 2006), and is executed in a process procedure shown in FIG. 2B.

An ID is requested from the wireless LAN access point 101 to a PC and an ID transmitted from the PC is notified as it is to the authenticating server 103 (process step P1-1).

The authenticating server 103 transmits a TLS start notice and receives a response to this notice from the PC (process step P1-2), and exchanges a server certificate for a client certificate (process step P1-3). The authenticating server 103 notifies the PC of encryption specifications (process step P1-4). Thereby, the TLS authentication is completed.

According to the conventional EAP-TLS, when the TLS authentication has been completed, an EAP layer returns a message determining that the authentication has been completed and permits an access of a PC.

In contrast, in the present invention, describing returning to FIG. 2A, the EAP does not transmit a message (EAP Success) that indicates permission of connection and transmits an EAP Response (process step P2).

In the TLS layer, TLS Application Protocol packets are transmitted/received. HTTP communication is executed on the TLS. Thereby, encrypted data communication can be executed between the PC and the authenticating server 103.

After connection of this TLS, the PC becomes an HTTP client (HTTP over TLS) and the authenticating server 103 is handled as an HTTP proxy.

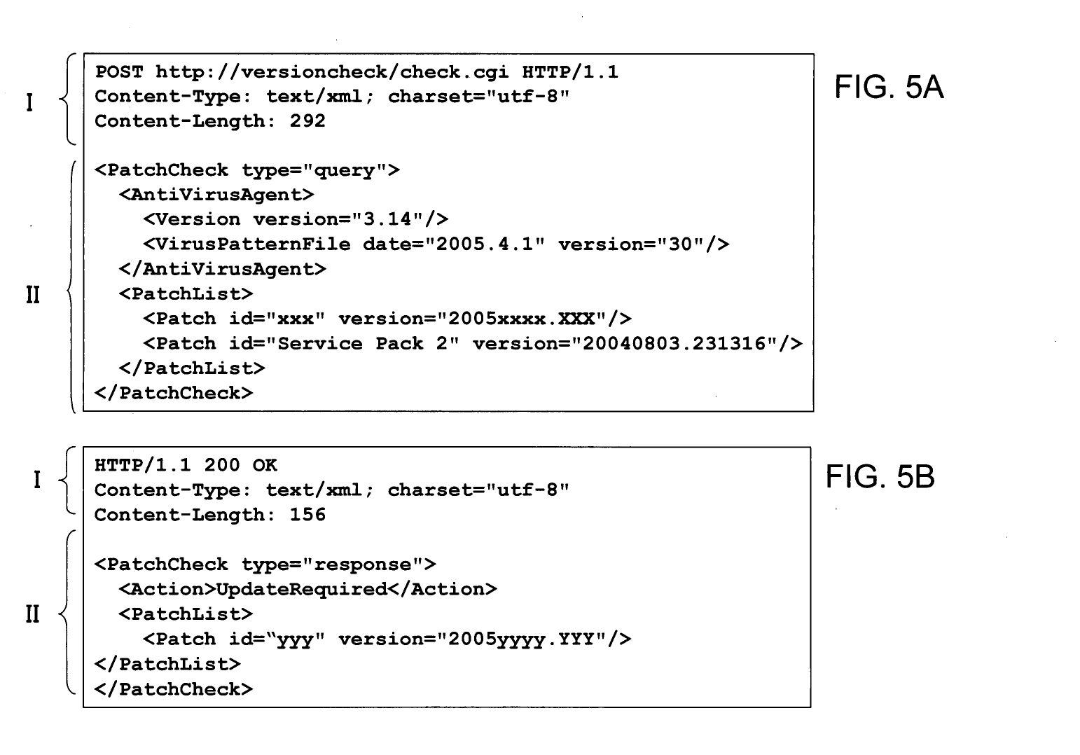

The PC transmits a file described with application state of a patch (difference), the version of the virus definition (date), etc., of the security program of the PC using an HTTP POST (transmission) message shown in FIG. 5A to the wireless LAN access point 101 (process step P2). The wireless LAN access point 101 transmits this message to the authenticating server 103 (process step P2, P3). In FIG. 5A, the HTTP POST (transmission) message consists of a header portion I and a main body data portion II.

A URL designated at this time is a URL upon which the PC and the authenticating server 103 have agreed in advance. The URL is, for example, http://quarantine-server/patch-status, etc.

The RADIUS authenticating server 103 reads the file received from the PC using the judging unit 103a (process step P4), and compares the file with the latest patch list prepared in advance on the server side (process step P5). When it has been judged that connecting the PC with the in-company LAN 100 arises no problem (process step P5, NO) the authenticating server 103 transmits the EAP-Success (process step P11, P12) and permits connection of PC with the network (process step P13).

At process step P5, when an important patch is not applied (process step P5, YES), the authenticating server 103 instructs the PC through the wireless LAN access point 101 to update (process step P6, P7).

That updating is necessary and a list of patches to be applied are outputted on a body II of a message shown in FIG. 5B of a response to the HTTP POST (transmission). These are returned to the PC as a TLS packet, that is, an encrypted packet.

The PC that has been instructed to update downloads the necessary patches using the HTTP and applies the patches (process step P8).

At this time, the authenticating server 103 accesses the Web site 110 for the updating as the HTTP proxy using the data providing unit 103b, and downloads a patch. To prevent the PC from accessing the Web with a purpose other than updating, access control that prohibits accesses to destinations other than the Web server for updating is executed to this proxy function.

A message indicating that the application of the patch has been completed is transmitted from the PC through the wireless LAN access point 101 to the authenticating server 103 (process step P9, P10). In response to this message, permission of connection of the PC with the network is informed by transmitting an EAP Success message from the authenticating server 103 through the wireless LAN access point 101 to the PC (process step P11, P12).

Thereby, after this, the PC can communicate with the Web server 102.

In the above description, an example of the case where the authenticating server 103 operates as an HTTP proxy is shown. However, it is obvious that the system can be changed as appropriate such that the patch is downloaded based on a protocol other than HTTP (for example, FTP: File Transfer Protocol, etc.).

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A network system comprising:
an access point that relays communication between a client and a LAN; and
an authenticating server that authenticate an access of the client through the access point, wherein the authenticating server comprises
a judging unit that judges the application state of a security program in the client that tries to connect with the LAN through the access point and notifies the client of the result of the judgment; and
a data providing unit that provides data necessary for updating the application state to the client according to the result of the judgment and in response to a request of the client.

2. The network system according to claim 1, wherein authentication of an access of the client based on EAP (Extensible Authentication Protocol)-TLS (Transport Layer Security) is executed prior to the judgment of the application state.

3. The network system according to claim 1, wherein the authenticating server compares the state of a patch of the security program received from the client with the latest patch list and notifies the client of the location of updating data necessary for the updating using TLS encryption.

4. The network system according to claim 3, wherein the authenticating server transmits a packet that indicates permission of a network access to the client when the authenticating server has received a message notice that indicates completion from the client.

5. An authenticating server disposed in a LAN and executes authentication when a client is connected with a network, wherein the authenticating server
judges the application state of a patch of a security program of a client that has a LAN function and that is connected with the LAN through a LAN access point, and,
as a proxy server, downloads data necessary for updating from an update site and executes updating of the security program of the client.

6. A network system comprising;
a wireless LAN access point in a wireless LAN; and
an authenticating server in a LAN that the wireless LAN access point is connected with, and wherein
the application state of a patch of a program in the client that has a wireless LAN function and that is connected with the LAN through the access point is judged by the authenticating server; and
the authenticating server, as a proxy of the client, downloads from an update site data necessary for updating and updates a security program of the client.

7. The network system according to claim 6, wherein authentication of an access of the client based on EAP (Extensible Authentication Protocol)-TLS (Transport Layer Security) is executed prior to the judgment of the application state of the patch of the program of the client that has the wireless LAN function.

8. The network system according to claim 6, wherein the authenticating server compares the state of a patch of the security program received from the client with the latest patch list and notifies the client of the location of updating data necessary for the updating using TLS encryption.

9. The network system according to claim 8, wherein the authenticating server transmits a packet that indicates permission of a network access to the client when the authenticating server has received a message notice that indicates completion from the client.

10. An authenticating server disposed in a wireless LAN and executes authentication when a client is connected with a network, wherein the authenticating server
judges the application state of a patch of a security program of a client that has a LAN function and that is connected with the wireless LAN through a wireless LAN access point, and,
as a proxy server, downloads data necessary for updating from an update site and executes updating of the security program of the client.
